(19) United States
(12) Patent Application Publication
(10) Pub. No.: US 2012/0152929 A1
(43) Pub. Date: Jun. 21, 2012

(54) COVERING SYSTEM AND MOTOR VEHICLE WITH A COVERING SYSTEM

(76) Inventor: Markus Hintennach, Reichenbach (DE)

(21) Appl. No.: 13/328,480

(22) Filed: Dec. 16, 2011

(30) Foreign Application Priority Data
Dec. 20, 2010 (DE) 102010063595.2

(51) Int. Cl. H05B 1/00

(52) U.S. Cl. 219/202

(57) ABSTRACT

A covering system, in particular for a motor vehicle, with a sheet-like structure which can be shifted between a stowage state and a use state. The covering system is designed as a roller blind system, wherein the sheet-like structure is flexible, and wherein the roller blind system has a roller blind shaft, to which an edge of the sheet-like structure is fastened and onto which the sheet-like structure can be wound into a stowage stage and from which the sheet-like structure can be unwound into a functional state. An electrically operated heating device is provided on the sheet-like structure and/or on an extension rod which closes off the sheet-like structure on the end side.

### CROSS REFERENCE TO RELATED APPLICATIONS

This application claims the priority of German Patent Application No. 10 2010 063 595.2 filed on Dec. 20, 2010, the entire disclosure of which is hereby incorporated by reference into this application.

### FIELD OF USE AND PRIOR ART

The invention relates to a covering system, in particular for a motor vehicle. One such covering system of the type in question has a sheet-like structure which can be shifted between a stowage state and a use state.

Covering systems of the type in question are known in general from the prior art. They can be designed, for example, as roller blind systems, wherein the sheet-like structure in this case is designed as a flexible sheet-like structure, and wherein a roller blind shaft is provided, to which one edge of the sheet-like structure is fastened. The sheet-like structure can be wound up on the roller blind shaft in a stowage state and can be unwound from the roller blind shaft to reach a functional state. Another alternative of a covering system of the type in question, which is the basis of the present invention, has a sheet-like structure which is thin-walled, but is substantially rigid and therefore panel-like and which, guided by a guide fixed to the vehicle, is displaceable between a stowage position and a functional position.

Covering systems of the type in question are used in particular as covering systems in the region of window openings and as boot space coverings or separating nets between a passenger region and a luggage region.

DE 10 2008 047 508 A1 discloses covering systems designed as roller blind systems. The document mentioned furthermore discloses various options for supplying illumination units on an end strip of the roller blind system with current.

Furthermore, it is generally customary for motor vehicles to have heating devices in order to heat the interior of the motor vehicle, in particular in the event of low outside temperatures. Said heating devices are customarily designed to transport heated air into the interior of the vehicle.

### OBJECT AND SOLUTION

It is the object of the invention to expand a covering system of the type in question in respect of the functionality thereof.

According to the invention, this object is achieved in that an electrically operated heating device is provided on the sheet-like structure and/or on an extension rod which closes off the sheet-like structure on the end side.

In the case of the covering system according to the invention, use is therefore made of the movable part of the covering system, i.e. the sheet-like structure itself or an extension rod which closes off the sheet-like structure and can be provided in the form of a handle in order to generate heat on said covering system from the power supplied electrically. This can fulfil various purposes. Firstly, it can serve the purpose of freeing vehicle windows from ice in winter. In particular, however, the configuration according to the invention of a covering system with a heating device in the sheet-like structure or on the extension rod is considered to be advantageous for heating the interior of the vehicle. It is thus possible precisely to cover the vehicle windows, which are perceived as being unpleasantly cold in winter, with the sheet-like structure in the functional state thereof and to allow a heating effect to spread out. Depending on the configuration of the heating device, the electric heat is predominantly converted in the process into heat radiation which generates a subjectively particularly pleasant form of heat for the vehicle occupants.

In an alternative of the invention, a heating device of this type can be provided on a sheet-like structure which is rigid and is in the manner of a panel and which, guided by a guide device, preferably by two guide rails provided on both sides of the sheet-like structure, can be displaced between the stowage position and the functional position. Covering systems of this type are customary in particular in the roof region of vehicles having a glass roof or having a partially glazed roof.

The configuration according to the invention is preferably realized in a roller blind system, wherein the sheet-like structure in this case is designed as a flexible sheet-like structure, and wherein the covering system in this case comprises a roller blind shaft, to which one edge of the flexible sheet-like structure is fastened. The sheet-like structure can be wound up onto said roller blind shaft into a stowage state, and the sheet-like structure can be unwound from said roller blind shaft into a functional state. Systems of this type are customary in particular for covering side windows and the rear window of vehicles.

The heating device itself can be realized in various ways. It is possible in particular for use to be made of heating wires which can be designed with or without electric insulation depending on the electric power supplied. The heating wires may be formed metallically, for example from plastic. However, non-metallic, current-conducting heating conductors, for example made of carbon, are also known and can be used here. Furthermore, use may also be made of threads, in particular synthetic threads, such as polyester threads or polyamide threads, which are provided with a metallic covering, for example of silver. Furthermore, the use of heating foils which are commercially available and are premanufactured in a finished state may also be expedient. Such heating foils, which have hitherto been used, for example, for floor heating systems and the like, are available in very thin configurations of 0.2 mm-0.4 mm. A common feature of the various heating devices is that they convert electric power into heat, for example by acting as an electric resistor.

Current can be supplied to the heating device via the roller blind shaft itself. It is also possible to use guide rails of the covering system, through which the extension rod is movable in a guided manner, to supply current. Examples of both types of current supply can be gathered from DE 10 2008 047 508 A1,the content of which in this regard is incorporated into the content of this disclosure by explicit reference.

The heating device may extend substantially over the entire surface of the sheet-like structure or may only be provided in part thereof. It is advantageous, but not absolutely required, if the heating device is subdivided into a plurality of heating segments which are provided at various locations of the sheet-like structure and which can be operated independently of one another. This permits a specific heating effect at a specific location of the sheet-like structure while the heating device remains deactivated at another location. This is expedient, for example, in order, in the case of a flexible sheet-like structure which is only partially unwound from the roller blind shaft or in the case of a rigid sheet-like structure which is only partially pulled out of a receiving shaft, to heat only the part which has already been unwound or pulled out. The segments are therefore preferably spaced apart at a differing distance from that edge of the sheet-like structure which is connected to the roller blind shaft or from the extension rod of said sheet-like structure. In order to activate various heating segments, it is possible for a heating device controller to be provided which can activate the heating segments in a freely selectable manner. However, it is also possible to provide a mechanical coupling to the rotational position of the roller blind shaft or to the extension position of the dimensionally stable sheet-like structure, by means of which only those heating segments which are already in the functional position thereof can be heated.

For arranging the heating device on the sheet-like structure, one option is to design the sheet-like structure as a knitted fabric or knitted product, wherein the heating device has at least one heating wire or at least one metallically coated thread, which is part of the knitted fabric or of the knitted product. In such a case, the heating device therefore becomes an integral part of the knitted product or of the knitted fabric. The heating wires or coated heating threads are inserted as warp or weft threads of the fabric or as stitch-forming threads of the knitted product. This enables production of a particularly thin sheet-like structure, the suitability of which as a heating device can hardly be identified visually. As an alternative thereto, the heating device may also be provided on an outside of the sheet-like structure.

It is also possible to arrange the heating device between two separate layers of the sheet-like structure. This can be undertaken, for example, with the abovementioned heating foil.

In principle, the heating device can serve in a covering system according to the invention both to radiate heat outwards, in particular for deicing windows, and also to radiate heat inwards for the purpose of heating the interior. However, in the present case, the heating of the interior is considered to be the more important function. It is therefore considered advantageous if the sheet-like structure is designed in such a manner and the arrangement of the heating device in the sheet-like structure is selected in such a manner that at least the predominant part (>50%) of the output heat energy is output in the direction of the interior of the vehicle. Said portion is preferably even higher and is in particular preferably >70%. Said value refers to the total amount of energy output in the form of heat, i.e. both to the radiation of heat and heat output by means of convection.

The specific outputting of heat inwards can also be achieved, for example, by the heating device being provided on that side of the sheet-like structure which faces the interior. Likewise, in the case of two or more separate layers, between which the heating device is arranged, the direction in which the heat is radiated can be specifically influenced. It is thus possible, by means of a heat-reflecting or heat-blocking outer layer, for the heat from the heating device to be predominantly directed into the interior of the vehicle The radiation direction can also be influenced by different thicknesses of the two separate layers.

The invention furthermore also relates to a motor vehicle with a covering system of the type described above.

In the event of use in a motor vehicle, a covering system according to the invention can be designed as a loading-region covering system, in particular loading-region roller blind system, the sheet-like structure of which in the functional state separates a passenger region of the vehicle from a boot space. A loading-region covering system of this type can form, for example, a separating device which can be unwound vertically and is arranged behind the rear seat bench of a vehicle. It is also possible for a loading-region covering system to be designed as a boot space covering which, in the functional state, extends horizontally over the loading region. The use of a covering system which is designed in particular as a roller blind system and as a shading covering system and, for this purpose, in a functional state covers a window opening of the vehicle, is particularly advantageous. In addition to the shading effect thereof against incident light, a roller blind system of this type therefore also carries out the heating function already described above. Since specifically the vehicle windows are perceived as being unpleasantly cold in winter, a heating device in the region of the vehicle windows is particularly advantageous.

### BRIEF DESCRIPTION OF THE DRAWINGS

Further aspects and advantages of the invention emerge, apart from the claims, also from the description below of preferred exemplary embodiments of the invention. The latter are explained with reference to the figures, in which:

FIG. 1 shows a motor vehicle according to the invention with a covering system according to the invention in the manner of a roller blind system in a window region of the motor vehicle,

FIG. 2 shows the roller blind system of FIG. 1 in an enlarged illustration,

FIG. 3 shows a second embodiment of a roller blind system according to the invention, and

FIG. 4 shows a third embodiment of a roller blind system according to the invention.

### DETAILED DESCRIPTION OF THE EXEMPLARY EMBODIMENTS

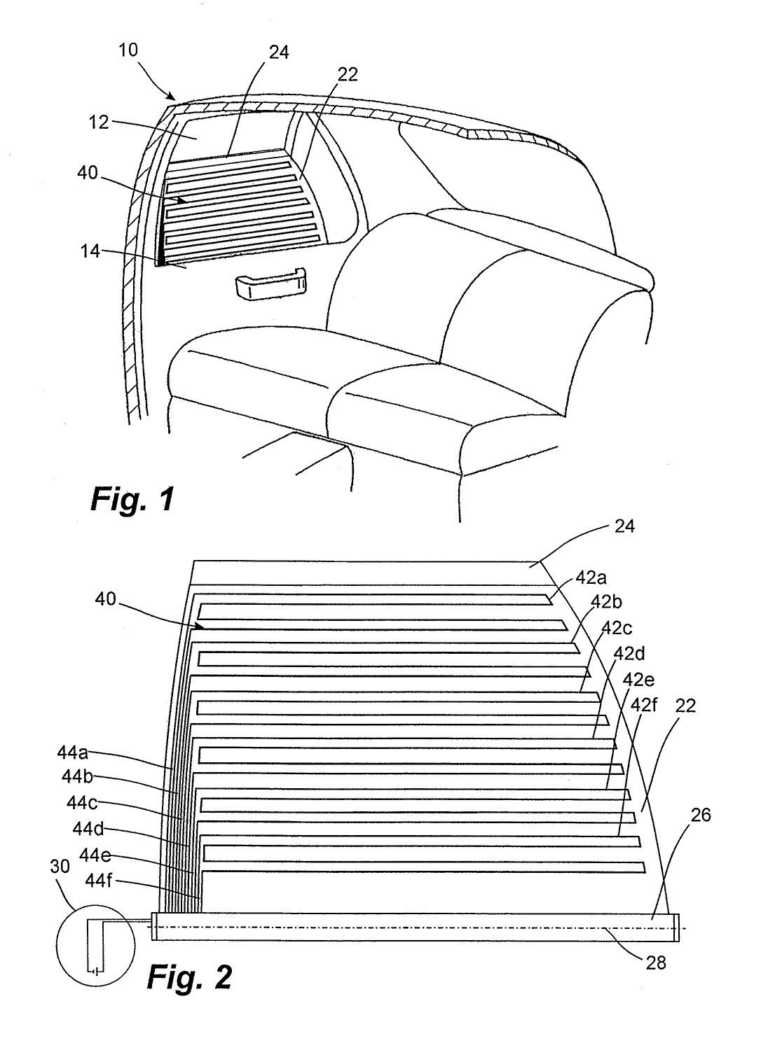

FIG. 1 shows a motor vehicle 10 according to the invention with a covering system 20 according to the invention in the form of a roller blind system 20. The roller blind system 20 is arranged in the motor vehicle 10 in the region of the window 12 of a rear vehicle door. The roller blind system has a sheet-like structure 22, at the distal end of which an extension rod 24 is provided. The opposite end of the sheet-like structure 22 is attached to a roller blind shaft 26 which is illustrated in FIG. 2 and is mounted so as to be rotatable about a roller blind shaft axis 28 in order to roll up and unroll the sheet-like structure 22. The sheet-like structure can therefore be moved between a functional position, in which it completely covers the window 12 of the vehicle 10, and a stowage position, in which the extension rod 24 is lowered as far as the level of the window breast 14. The extension rod 24 can be guided in a manner not illustrated specifically by a guide rail which is provided on that side of the window frame of the window 12 which is on the left with reference to FIG. 1.

A heating device 40 is provided on the sheet-like structure 22. Said heating device comprises a total of six heating loops 42a, 42b, 42c, 42d, 42e, 42f which are separated from one another. Said heating loops consist of heating wire or metallically sheathed threads. The individual heating loops 42a, 42b, 42c, 42d, 42e, 42f each extend substantially horizontally and are spaced apart at differing distances from the roller blind shaft 26. Each heating loop 42a, 42b, 42c, 42d, 42e, 42f is in each case assigned two current lines 44a, 44b, 44c, 44d, 44e, 44f which are fitted in a border region of the sheet-like structure 22 and by means of which the heating loops can be supplied with current. By means of the configuration thereof with a resistance wire or a resistance sheath around a plastic thread, the heating loops 42a to 42f are able to heat up when a current is applied and to emit the heat generated in this manner into the interior of the vehicle by heat radiation and/or by convection. The heating loops 42a to 42f are supplied with electric power by a current source 30. This preferably involves the electrical system of the vehicle.

By means of the division of the heating device into separate heating loops 42a to 42f, it is possible only partially to heat the sheet-like structure 22. By this means, in particular if the roller blind is only partially unrolled, as illustrated in FIG. 1, it is possible to prevent that part of the sheet-like structure which is still rolled up on the winding shaft from also being heated.

In addition to fitting the heating loops 42a to 42f on one side, preferably on the inside, of the sheet-like structure, there are also further fitting options.

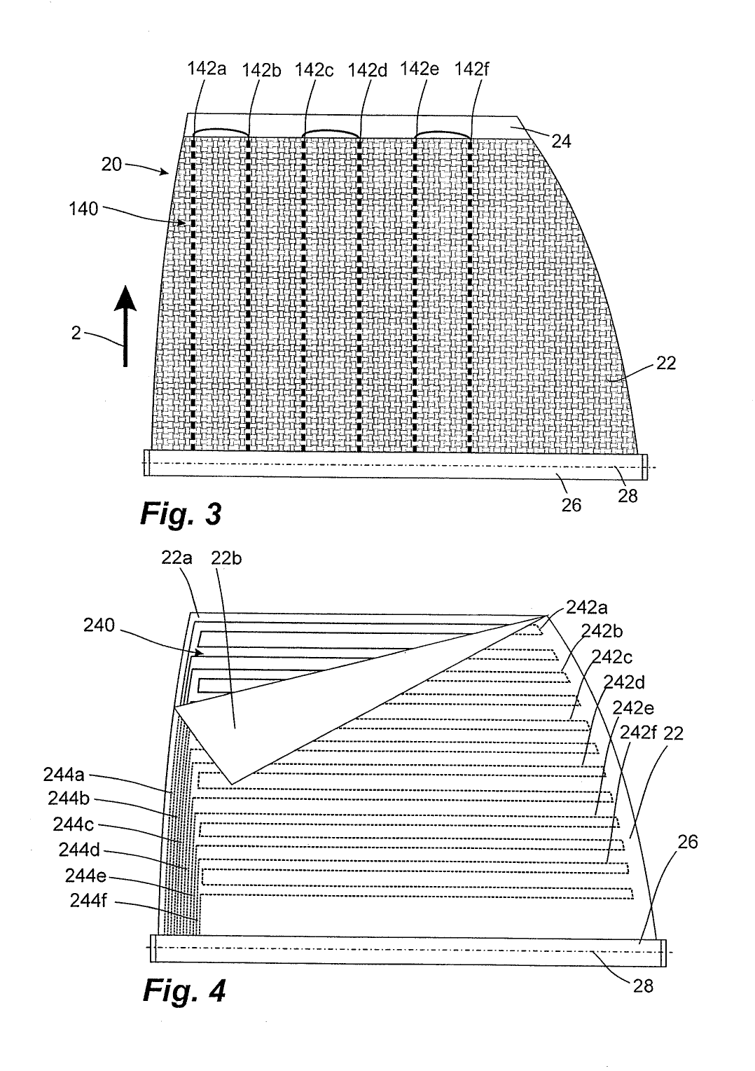

FIG. 3 shows, by way of example, in schematic form a configuration, in which the heating device 140 primarily consists of the heating conductors 142a, 142b, 142c, 142d, 142e, 142f which are stretched out in the extension direction 2 and are a direct part of the fabric forming the sheet-like structure 22. In the region of the extension rod 24, said six heating conductors 142a-142f are connected to one another in pairs. In the region of the roller blind shaft 26, the pairs of heating conductors, which are connected in series or in parallel, can be connected to the current source (not illustrated in FIG. 3).

In the configuration of FIG. 4, the sheet-like structure 22 is a double-layered design. In this case, an outwardly facing layer 22a of the sheet-like structure is less suitable than an inwardly facing layer 22b to allow the passage of heat generated by a heating device 240 arranged between the layers 22a, 22b. For this purpose, said inwardly facing layer can be formed, for example, with a low coefficient of thermal conduction. It may furthermore also be designed so as to reflect heat. The heat generated by the heating device 240 is therefore irradiated into the interior by the layer 22b facing the interior.

The heating device 240 itself is designed in a similar manner to the heating device 40 of FIGS. 1 and 2. It in turn comprises separate heating loops which can be activated separately from one another. The heating loops may themselves be part of a heating foil which is placed as a whole between the layers 22a, 22b.

The covering systems illustrated are designed as roller blind systems having flexible sheet-like structures. In alternative configurations (not illustrated), the sheet-like structures are of dimensionally stable and therefore panel-like design and are pushed as a whole and without being deformed in the stowage state thereof into a receiving shaft. This is expedient in particular in the case of covering systems for roof windows of a vehicle.

The configuration according to the invention permits heating of a vehicle interior or, if required, also of vehicle windows of the vehicle. In this case, the heating device can be accommodated virtually invisibly because of the arrangement thereof on the sheet-like structure or alternatively on the extension rod and therefore does not interfere with the aesthetic impression of the vehicle and of the covering system. Depending on the configuration of the heating conductors, the heat radiated by the heating device can be present in particular as heat radiation which is perceived by vehicle occupants to be particularly pleasant.

1. Covering system (20), in particular for a motor vehicle (10), with a sheet-like structure (22) which can be shifted between a stowage state and a use state, characterized in that an electrically operated heating device (40; 140; 240) is provided on the sheet-like structure (22) and/or on an extension rod (24) which closes off the sheet-like structure on the end side.

2. Covering system (20) according to claim 1, characterized in that the covering system (20) is designed as a roller blind system (20), wherein the sheet-like structure (22) is designed as a flexible sheet-like structure (22), and wherein the roller blind system (20) comprises a roller blind shaft (26), to which an edge of the sheet-like structure (22) is fastened and onto which the sheet-like structure (22) can be wound into a stowage stage and from which the sheet-like structure (22) can be unwound into a functional state.

3. Covering system (20) according to claim 1, characterized in that the heating device (40) has
a heating foil (40; 42a-42f; 240, 242a-242f),
a heating wire (42a-42f, 142a-142f, 242a-242f) or
a metallically coated thread (42a-42f, 142a-142f, 242a-242f).

4. Covering system (20) according to claim 1, characterized in that the heating device (40) has a plurality of heating segments (42a, 42b, 42c, 42d, 42e, 42f; 242a, 242b, 242c, 242d, 242e, 242f) which are provided at various points of the sheet-like structure and which are operable independently of one another.

5. Covering system (10) according to claim 1, characterized in that the sheet-like structure (22) is designed as a knitted fabric or knitted product, and the heating device (140) has at least one heating wire (142a, 142b, 142c, 142d, 142e, 142f) or at least one metallically coated thread (142a, 142b, 142c, 142d, 142e, 142f), which is part of the knitted fabric or of the knitted product.

6. Covering system (20) according to claim 1, characterized in that the heating device (240) is arranged between two separate layers (22a, 22b) of the sheet-like structure (22).

7. Covering system (20) according to claim 1, characterized in that the sheet-like structure (22) is designed in such a manner and/or the arrangement of the heating device (40, 140, 240) in the sheet-like structure is selected in such a manner that at least the predominant part (>50%) of the heat energy output is output in the direction of the interior of the vehicle.

8. Covering system (20) according to claim 7 characterized in that the sheet-like structure (22) is designed in such a manner and/or the arrangement of the heating device (40, 140, 240) in the sheet-like structure is selected in such a manner that at least more than 70% of the heat energy output is output in the direction of the interior of the vehicle.

9. Motor vehicle (10) with a covering system (20), characterized in that the covering system (20) is designed according to claim 1.

10. Motor vehicle (10) according to claim 9, characterized in that
the covering system is designed as a loading-region covering system, the sheet-like structure of which in the functional state separates a passenger region of the vehicle from a boot space, or
the covering system (20) is designed as a shading covering system, the sheet-like structure of which in the functional state covers a window opening (12) of the vehicle.
